(19) United States
(12) Patent Application Publication
(10) Pub. No.: US 2017/0129083 A1
(43) Pub. Date: May 11, 2017

(54) Device and Method for Broken Extractor Removal

(71) Applicant: Ray Fitzgerald Woods, Salem, OH (US)

(72) Inventor: Ray Fitzgerald Woods, Salem, OH (US)

(21) Appl. No.: 15/410,262

(22) Filed: Jan. 19, 2017

Related U.S. Application Data
(62) Division of application No. 14/668,881, filed on Mar. 25, 2015.

(51) Int. Cl. B25B 27/18

(52) U.S. Cl. CPC B25B 27/18

(57) ABSTRACT

A device and method of extracting a broken extractor are provided. The fastener extractor includes a shaft with a pre-formed center hole situated longitudinally and interiorly in the fastener extractor. An extractor removal tool is provided that is pre-formed to engage the pre-formed center hole in the extractor for removing a broken extractor and debri.

### CLAIM FOR PRIORITY

The present application is a Divisional of application Ser. No. 14/668,881 filed Mar. 25, 2015 with the United States Patent and Trademark Office. The subject matter of which is incorporated herein in its entirety.

### BACKGROUND

1. Field

The present invention relates to traditional extractors used for removing broken threaded fasteners and more specifically extracting a broken extractor from a broken fastener.

2. Description of Related Art

Conventional extractors are round or square, solid, formed to a point, and spiral fluted or straight fluted. The spiral fluted extractors are threaded in the opposite direction of the broken fastener that is to be removed and square extractors have straight flutes. The extractor is formed so that once the broken fastener is center drilled the extractor is then inserted and rotated to remove the broken fastener. These conventional extractors leave no room for error in the aspect that if the extractor breaks or snaps off while attempting to remove the damaged fastener, it leaves a broken extractor inside of the broken fastener, therefore creating a compounded problem.

Traditional extractors are comprised of very hard steel, usually case hardened or heat treated, causing the steel to become so hard that it is almost brittle. It is well known to those that have utilized the conventional extractor not to drop them on concrete or other equally hard surfaces as it can easily compromise the strength of the extractor and will likely fail when used. Extractors are not easily drilled into by the common drill bit therefore, ruining multiple drill bits to achieve a deep enough hole in the broken extractor for it's removal. In some cases, removal of the broken extractor from the broken fastener cannot be achieved. This can present a time consuming and labor intensive process that can result in further damage or destruction of the bored component.

Many different extractors have been invented solving various problems presented while attempting to remove a damaged fastener, see for example U.S. Pat. Nos. 1,458,076, 1,754,736, 1,798,944, 1,875,484, 5,466,100, 6,098,499 and 7,152,509.

In U.S. Pat. No. 1,458,076 an “Extracting Device” having a nut member and angular portion that is engagable by a turning tool.

U.S. Pat. No. 1,754,736 is a “Screw Extractor” providing a tapered end with spiraled tapering with a blank surface between threads.

U.S. Pat. No. 1,798,944 claims a self-centering extractor with an impact head for hammering and flat narrow surfaces to allow for better seating in the broken fastener.

U.S. Pat. No. 1,875,484 discloses an extractor having a square body used to transmit rotational forces on the wall of the screw without shearing the metal.

U.S. Pat. No. 5,466,100 is directed to an extractor having a multispeed power drill bit with handle chuck adapter. This extractor has a hexagonal shank and multiple cylindrical surfaces with a decreasing diameter and a groove extending down the shank.

U.S. Pat. No. 6,098,499 is yet another extracting tool that has a tap member and driving head end and broach end.

U.S. Pat. No. 7,152,509 titled “Fastener Extractor” comprises an extractor and hand tool used on the end of the extractor for removing the fastener.

Accordingly, it is evident these conventional extractors do not address the possibility of the extractor itself being compromised while attempting to remove a damaged fastener, thus further complicating the fastener removal process. Therefore, it would be desirable to have a fastener extractor that did not need to be drilled in the event it broke off in the fastener and an extractor removal tool that overcomes one or more of the disadvantages of the conventional extractor.

### BRIEF SUMMARY OF THE INVENTION

To alleviate the disadvantages of prior art, a fastener extractor and an extractor removal tool is provided herein. The present invention comprises the conventional extraction tool for broken fasteners. Conventional extractors are normally round or square, solid, and formed to a point or taper from the head to the tapered end having gripping teeth, edges, surfaces, flutes, etc. on the outside of the shaft of the extractor that grip the drilled out broken fastener when the extractor is inserted and turned in the opposite direction of the threaded bolt. The head is formed to have a surface for a wrench, or other hand tool to engage for removal of the broken fastener.

The present invention comprises the conventional extractor having a pre-formed hole longitudinally and interiorly located through the center of the extractor with the hole opening situated in the center of the head of the extractor. The pre-formed center hole runs through the entire extractor from an opening in the head to an opening in the distal end being the tip or tapered end. The pre-formed center hole can be machined in the fastener extractor in various forms including but not limited to square, round, threaded, hexagon, octagon, cross, star, or ribbed. The extractor's hardened steel provides strength and rigidity even with a center hole pre-formed longitudinally. The pre-formed center hole also serves as a storage compartment for the extractor removal tool that when in its stored position provides additional strength to the extractor by filling the void in the pre-formed center hole. In the event the extractor fractures, the pre-formed center hole allows for ease of removal of the fractured extractor with the extractor removal tool. Thus eliminating the step of trying to drill out the conventional extractor, which is tedious, time consuming and sometimes impossible due to the nature of the heat-treated steel from which the extractor is composed. The extractor removal tool is pre-formed to fit inside the current invention so that when rotated will remove the compromised extractor for ease of removal from the broken fastener. The extractor removal tool can be comprised of hard steel (ex. 4140 steel or the like thereof because there are various metal compositions with lower carbon that provide both qualities) that allows the steel of the removal tool to grip and bite the interior of the broken extractor all while the steel will flex enough that the extractor removal tool won't compromise. This allows for an uncompromised extractor with pre-formed center hole to be inserted in the broken fastener and the process starts again. The current invention alleviates the possibility of permanently damaging the bored component and the necessity of drilling into the heat-treated steel of the fastener extractor, which is consequently a long involved process and many times unachievable.

### BRIEF DESCRIPTION OF THE DRAWINGS

FIG. 1 is a perspective view of the current invention showing the extractor with a pre-formed square center through hole and spiral flutes.

FIG. 2 is a perspective view example of an extractor removal tool that is pre-formed to fit in the center hole of the extractor.

FIG. 3 is a perspective view of the current invention as a spiral fluted extractor showing the extractor removal tool stored in the extractor with pre-formed center through hole.

### DETAILED DESCRIPTION OF THE INVENTION

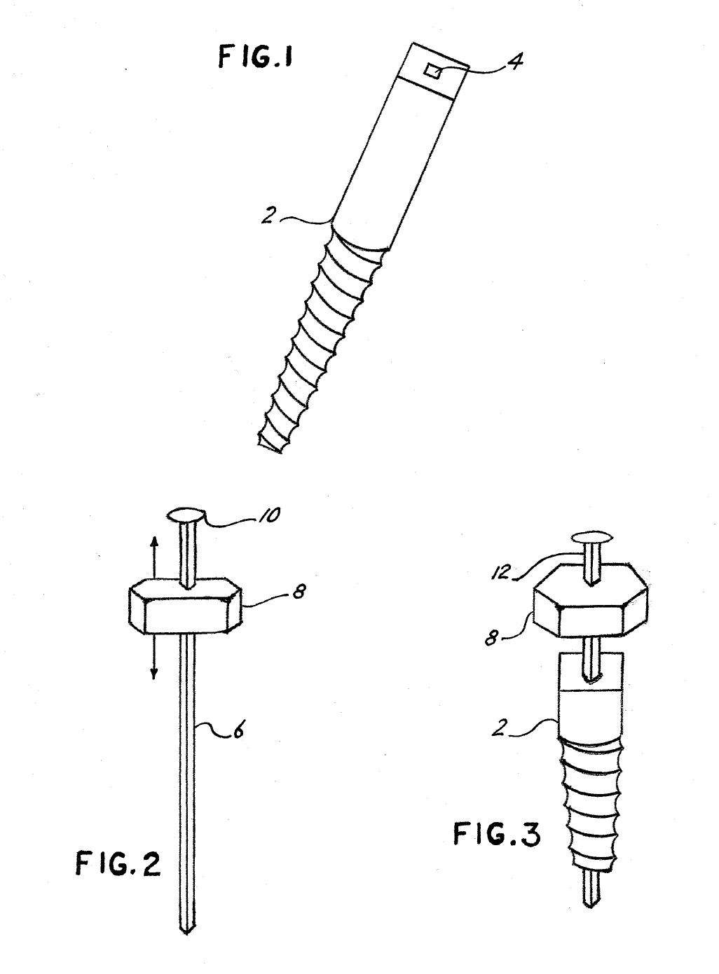

FIG. 1 is a perspective view of the current invention, an extractor with a through pre-formed center hole 2 comprised of case hardened or heat treated steel having a pre-formed center hole 4 longitudinally located through the center of the extractor with an opening in the center of the head and the distal end. The fastener extractor with a through pre-formed center hole 2 having a head with a plurality of surfaces and ridges adapted to be engaged with a wrench or other hand tool of the like. The distal end being the tapered, broach end is comprised of various gripping teeth, edges, and surfaces on the exterior of the extractor used to grip a broken fastener. FIG. 2 is a perspective view of a square extractor removal tool 6 and components. The extractor removal tool 6 having a longitudinal axis is further defined by having a sliding head 8, a head keeper 10, and a distal end shaft. The sliding head 8 of the square extractor removal tool 6 is formed with a through center hole engagable on the shaft of the extractor removal tool 6 and is able to slide freely on the shaft allowing the sliding head 8 to move closer to a bored component containing a broken fastener and broken extractor for ease in removing the broken extractor. Above the sliding head 8 attached to the shaft of the square extractor removal tool 6 is the head keeper 10 that is pictured as a thin round piece of steel permanently attached to the removal tool shaft in FIGS. 2 and 3, and utilized to stop the extractor removal tool shaft from sliding through the bottom of the sliding head 8. The extractor removal tool 6 seats and engages in the pre-formed center hole 4 of the extractor with through pre-formed center hole 2. FIG. 3 is a perspective view showing an extractor removal tool in its stored position 12 within the extractor with through pre-formed center hole 2. The various shaped extractor removal tools can be comprised of hard steel with lower carbon composition and is pre-formed in a manner so that when inserted into an extractor with a pre-formed center hole 2, it fills the void of the pre-formed center hole 4. The hard steel (ex. 4140 steel, alloys or the like there of) comprising the extractor removal tool's 6 shaft, sliding head 8, and head keeper 10 allows for the removal tool to flex rather than break but is rigid enough to grip or bite the interior walls of the extractor while being rotated to remove a broken extractor with a pre-formed center hole 4. The various extractor removal tools can also be magnetized to aide in the extractor and debri removal. The through pre-formed center hole 4 of the extractor, the extractor removal tool's 6 shaft, and through hole of the sliding head 8 can be machined or formed in a plurality of shapes including but not limited to: circle, square, cross, hexagon, octagon, ribbed, threaded, star, etc. Rotating the extractor removal tool 6 in the opposite direction the extractor was applied allows for easy removal of the broken extractor with pre-formed center hole. Once a broken extractor with pre-formed center hole 4 is removed from a broken fastener, the process is repeated using an unbroken extractor with a pre-formed hole 2 to remove the broken fastener.

Due to the case hardening or heat treating of the steel used to construct extractors, machining of the pre-formed center hole 4 must occur before the hardening process takes place in order to allow for easy and economical machining. It is assumed that one skilled in the art has knowledge of the aforementioned hardening process. While the present invention has been described in both summarized and detailed form, it is understood that the through pre-formed center hole 4, extractor removal tool's 6 shaft, and center hole in the sliding head 8 as seen in FIGS. 1, 2, and 3 can be machined in various shapes (ex. hexagon, octagon, circle, cross, square and able to be ribbed or threaded etc.) and can be integrated into various types and brands of extractors without departing from the spirit of the invention.

Therefore I claim:

1. A fastener extractor comprising:
a shaft defining a longitudinal axis:
a shaft member comprised of steel having a head with engagement opening and a distal broach end, said engagement opening being a machined and pre-formed center hole positioned interiorly and longitudinally through a center of the extractor shaft;
the pre-formed center hole having a plurality of surfaces further comprised of various shapes depending on application and being a through hole that extends through the distal end of the extractor broach end; and
where in said through hole defines a passage adapted to be engaged with an extractor removal tool for removing a broken extractor from a broken fastener; and
said shaft being conical or polygonal with a plurality of gripping or biting surfaces arid edges along the longitudinal axis being the broach end utilized to engage a drilled hole in a fastener to be removed; and
the head having a plurality of surfaces and ridges exteriorly adapted to be engaged with a wrench or other hand tool to forcibly engage the extractor into a drilled hole in a broken fastener to be removed.

2. An extractor removal tool comprising:
a shaft defining a longitudinal axis:
a shaft member comprised of low carbon steel or alloy also being magnetized, having a head with a plurality of surfaces and ridges adapted to be engaged with a wrench or other hand tool with the shaft exterior having a machined and pre-formed shape conformed to fill the void of a fastener extractor with a pre-formed center hole; and
said head having a center hole pre-formed to engage on the shaft and allow the head to slide freely on the shaft; and
the shaft member having a length such that when positioned in a downward most position within the fastener extractor with pre-formed center hole, extends above the head of the extractor when in the seated or stored position; and
said shaft member having a head keeper to alleviate the head from sliding off a top of the shaft; and
said shaft member having a rotational direction opposite of the fastener extractor.

3. A method of extracting a damaged extractor comprising:
the absence of drilling an opening into the hardened steel of a broken extractor;
providing a fastener extractor having a shaft defining a longitudinal axis;
the shaft member of steel having a head with engagement opening and a distal broach end, with said engagement being a machined and pre-formed center hole positioned interiorly and longitudinally through a center of the extractor shaft, where the pre-formed center hole has a plurality of surfaces further comprised of various shapes depending on application and having a through hole that extends through the distal end of the extractor broach end, where in said through hole defines a passage adapted to be engaged with an extractor removal tool for removing a broken extractor from a broken fastener and, with said shaft being conical or polygonal with a plurality of gripping or biting surfaces and edges along the longitudinal axis being the broach end utilized to engage a drilled hole in a fastener to be removed, and the head having a plurality of surfaces and ridges exteriorly adapted to be engaged with a wrench or other hand tool to forcibly engage the extractor into a drilled hole in a broken fastener to be removed; and providing an extractor removal tool comprising;
a shaft defining a longitudinal axis where the shaft member is comprised of low carbon steel or alloy also being magnetized, and having a head with a plurality of surfaces and ridges adapted to be engaged with a wrench or hand tool, with said head being able to slide freely along said shaft exterior, and said shaft member having a machined and pre-formed shape conformed to fill the void of a fastener extractor with a pre-formed center hole, where the shaft member has a length such that when positioned in a downward most position within the fastener extractor with pre-formed center hole, the extractor removal tool head extends above the head of the extractor when in a seated or stored position, and the extractor removal tool has a rotational direction opposite of the fastener extractor, and said shaft curtails the head at the top of the shaft with a thin flat steel head keeper attached to the top of said shaft.

4. The method of claim 3 wherein inserting the extractor removal tool into the broken fastener extractor with pre-formed center hole comprises rotating said extractor removal tool in a opposite direction said fastener extractor was applied to a broken fastener.
